(19) United States
(12) Patent Application Publication
(10) Pub. No.: US 2019/0343725 A1
(43) Pub. Date: Nov. 14, 2019

(54) LIQUID DRUG TRANSFER DEVICES FOR USE WITH INTACT DISCRETE INJECTION VIAL RELEASE TOOL

(71) Applicant: West Pharma. Services IL, Ltd., Ra'anana (IL)

(72) Inventor: Igor DENENBURG, Gedera (IL)

(21) Appl. No.: 16/466,422

(22) PCT Filed: Nov. 29, 2017
(86) PCT No.: PCT/IL2017/051299

§ 371 Date: Jun. 4, 2019

(30) Foreign Application Priority Data
Dec. 6, 2016 (IL) 249408

(51) Int. Cl. A61J 1/20

(52) U.S. Cl. CPC A61J 1/2096; A61J 1/2048; A61J 1/2089

(57) ABSTRACT

Liquid drug transfer devices including an integral telescopic vial adapter for telescoping from an initial pre-compacted state to a final compacted state. In the initial pre-compacted state, the vial adapter telescopically snap fits on an initially non-punctured intact discrete injection vial leaving its injection vial stopper non-punctured. In the final compacted state, the vial adapter punctures the injection vial stopper. The liquid drug transfer device is used with an intact discrete injection vial release tool for applying a pincers-like compression for convenient release of a non-punctured intact discrete injection vial in the initial pre-compacted state. The vial adapter includes a clamping arrangement for irreversibly clamping same in the final compacted state. The vial adapter precludes release of a punctured discrete injection vial in its final compacted state.

### FIELD OF THE INVENTION

The invention relates to liquid drug transfer devices for use with a discrete injection vial.

### BACKGROUND OF THE INVENTION

Liquid drug transfer devices having an integral vial adapter for use with a discrete injection vial containing a medicament are available for home use, outpatient clinic use, hospital use, and the like. Exemplary liquid drug transfer devices having an integral vial adapter include inter alia a female vial adapter having a female Luer connector for use with a needleless syringe, a male vial adapter having a male Luer connector, a liquid drug transfer device having an integral administration device and a syringe port for attaching a needleless syringe thereto, a liquid drug transfer device for mixing contents of two injection vials to form a liquid drug for aspiration through a syringe port to a needleless syringe, and the like.

Discrete injection vials include a closed end vial tube typically containing an expensive medicament, a tubular vial crown having a crown opening and a vial neck intermediate the vial tube and the vial crown. Discrete injection vials include an injection vial stopper for hermetically sealing a crown opening and a band for capping the vial crown. Discrete injection vials typically include a flip-off tamper evidence cap intended to be irreplaceably removed immediately before use to expose an uppermost injection vial surface which is sterilized before accessing an injection vial.

Vial adapters have a generally inverted cup shape including an uppermost transverse vial adapter wall and a downward depending vial crown sleeve for bounding a vial crown cavity for receiving a vial crown on telescopic mounting a vial adapter on a discrete injection vial. The uppermost transverse vial adapter wall has a downward depending puncturing cannula with a proximal puncturing cannula opening and a distal puncturing cannula tip for concurrently puncturing an injection vial stopper on telescopic mounting a vial adapter on a discrete injection vial. A vial crown sleeve can optionally have one or more radial inward vial crown holding protrusions for snap fitting under a vial crown on telescopic snap fitting a vial adapter on a discrete injection vial for a more secure mounting.

Telescopic mounting a vial adapter on a discrete injection vial typically takes place adjacent a patient ready for immediate administration of its medicament. Telescopic mounting is considered a relatively problematic task for several reasons: First, healthcare providers having gloved hands have to be dexterous to handle a vial adapter and a discrete injection vial. Second, healthcare providers have to apply a relatively considerable force for concurrently telescopic mounting a vial adapter on a discrete injection vial and puncturing its injection vial stopper. Third, healthcare providers are prone to incorrectly aligning a vial adapter relative to a discrete injection vial such that its distal puncturing cannula tip doesn't puncture an injection vial stopper but rather is embedded therein. And fourth, in case of some medicaments, speed of administration is of utmost importance, and concurrent telescopic mounting a vial adapter on a discrete injection vial and puncturing its injection vial stopper can take a relatively long time.

There is a need to facilitate the use of liquid drug transfer devices having an integral vial adapter with a discrete injection vial.

### SUMMARY OF THE INVENTION

The present invention is directed towards liquid drug transfer devices with an integral telescopic vial adapter for use with an initially non-punctured intact discrete injection vial. In its pre-compacted state, the vial adapter telescopically snap fits onto an initially non-punctured intact discrete injection vial without puncturing its injection vial stopper. In its compacted state, the vial adapter punctures the injection vial stopper. The division of the hitherto single step of concurrent telescopic mounting and injection vial stopper puncturing into an initial step of telescopically snap fitting an integral telescopic vial adapter on a discrete injection vial and a subsequent step of compacting an integral telescopic vial adapter for puncturing its injection vial stopper enables the two steps to be performed either by the same healthcare provider or optionally two healthcare providers. In the latter case, a first healthcare provider can be located in a pharmacy, a sterile room, and the like, not adjacent patients and only the second healthcare provider is adjacent patients for administration purposes.

The sole or first healthcare provider has responsibility for telescopically snap fitting a liquid drug transfer device's integral telescopic vial adapter on a discrete injection vial to prepare a so-called Ready-To-Use (RTU) liquid drug transfer assemblage with a pre-attached non-punctured intact discrete injection vial. Puncturing an injection vial stopper requires a considerably greater force than telescopically snap fitting a vial adapter on a discrete injection vial such that a healthcare provider can be cognizant during compacting an integral telescopic vial adapter of the present invention to avoid inadvertently immediately proceeding to puncture an injection vial stopper after snap fitting on an intact discrete injection vial. The integral telescopic vial adapter can be optionally provided with a safety catch mechanism requiring a release action for priming same for enabling compaction. The release action can involve a relative rotation action, a relative linear displacement action, removal of a safety catch, and the like. The sole or first healthcare provider can be availed with apparatus, for example, jigs, and the like, for assisting preparing RTU liquid drug transfer assemblages. In the case of two healthcare providers, the second healthcare provider has the simpler task of compacting an integral telescopic vial adapter of a RTU liquid drug transfer assemblage for puncturing the injection vial stopper of the pre-attached non-punctured intact discrete injection vial adjacent a patient for administration purposes.

Dividing the hitherto concurrent telescopic mounting and injection vial stopper puncturing into two discrete steps can lead to preparation of a RTU liquid drug transfer assemblage for a particular patient which may no longer be required, for example, due to a change in the patient's state of health. The present invention envisages transferring the non-punctured intact discrete injection vial to a new liquid drug transfer device for preparing a new RTU liquid drug transfer assemblage for another patient. In other words, notwithstanding its tamper evidence cap has been irreplaceably removed, the discrete injection vial is still considered as being fit for administration as long as its injection vial stopper has not been punctured. Accordingly, the liquid drug transfer devices with an integral telescopic vial adapter of the present invention enable a pre-attached non-punctured intact discrete injection vial to be detached therefrom by means of an intact discrete injection vial release tool with an opposite pair of inward directed protrusions for applying a pincers-like compression. The intact discrete injection vial release tool can be configured as a pincers-like hand tool. Alternatively, the intact discrete injection vial release tool can be configured as a user operated electromechanical apparatus. The use of an intact discrete injection vial release tool for detachment of an intact discrete injection vial from an unused RTU liquid drug transfer assemblage affords that authorized healthcare providers only can detach same for use with a new liquid drug transfer device for preparing a new RTU liquid drug transfer assemblage.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of an administration set including a telescopic female vial adapter, a discrete injection vial, a needleless syringe and a pincers-like hand tool for releasing an intact discrete injection vial from the telescopic female vial adapter;

FIG. 2 is a longitudinal cross section of the discrete injection vial along a cross section line 2-2 in FIG. 1;

FIG. 3 is a front perspective view of the telescopic female vial adapter in its pre-compacted state;

FIG. 4A is an exploded top perspective view of the telescopic female vial adapter;

FIG. 4B is an exploded bottom perspective view of the telescopic female vial adapter;

FIG. 5 is a longitudinal cross section of the telescopic female vial adapter in its pre-compacted state telescopically snap fitted on the non-punctured intact discrete injection vial along a cross section line A-A in FIG. 3;

FIG. 6 is a longitudinal cross section of the telescopic female vial adapter in its pre-compacted state telescopically snap fitted on the non-punctured intact discrete injection vial along a cross section line B-B in FIG. 3;

FIG. 7 is a front elevation view showing the use of the pincers-like hand tool in the pre-compacted state for releasing the non-punctured intact discrete injection vial;

FIG. 8 is a longitudinal cross section showing the use of the pincers-like hand tool for releasing the non-punctured intact discrete injection vial along a cross section line C-C in FIG. 7;

FIG. 9 is a longitudinal cross section of the telescopic female vial adapter in its compacted state puncturing the discrete injection vial along the cross section line A-A in FIG. 3;

FIG. 10 is a longitudinal cross section of the telescopic female vial adapter in its compacted state puncturing the discrete injection vial along the cross section line B-B in FIG. 3;

FIG. 11 is a front perspective view of a liquid drug transfer device configured for use with a pair of initially non-punctured intact discrete injection vials and a needleless syringe;

FIG. 12 is a longitudinal cross section of the FIG. 11 liquid drug transfer device along a cross section line D-D in FIG. 11;

FIG. 13 is a pictorial view of a liquid drug transfer device for use with an infusion liquid container and an infusion set, and

FIG. 14 is a longitudinal cross section of the FIG. 13 liquid drug transfer device along a cross section line E-E in FIG. 13.

### DETAILED DESCRIPTION OF PREFERRED EMBODIMENT OF THE INVENTION

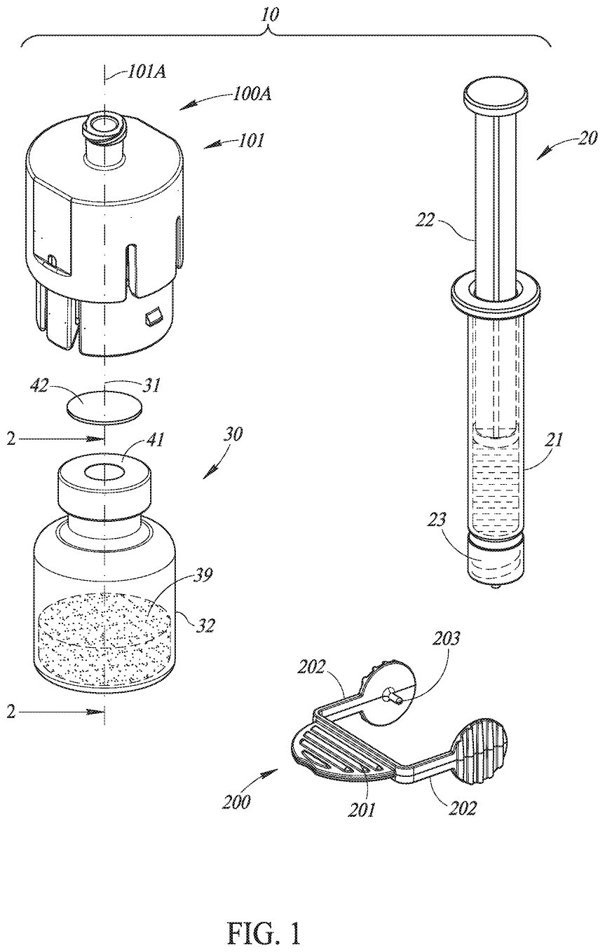

FIG. 1 shows an administration set 10 including a needleless syringe 20, an initially non-punctured intact discrete injection vial 30, a liquid drug transfer device 100A configured as a telescopic female vial adapter and an intact discrete injection vial release tool 200 for releasing the non-punctured intact discrete injection vial 30 from the liquid drug transfer device 100A.

FIG. 1 shows the needleless syringe 20 includes a syringe barrel 21 with a plunger rod 22 and a male connector 23. The male connector 23 is preferably a male Luer lock connector. The needleless syringe 20 contains liquid contents. The liquid contents are typically diluent only. The liquid contents can include an active ingredient.

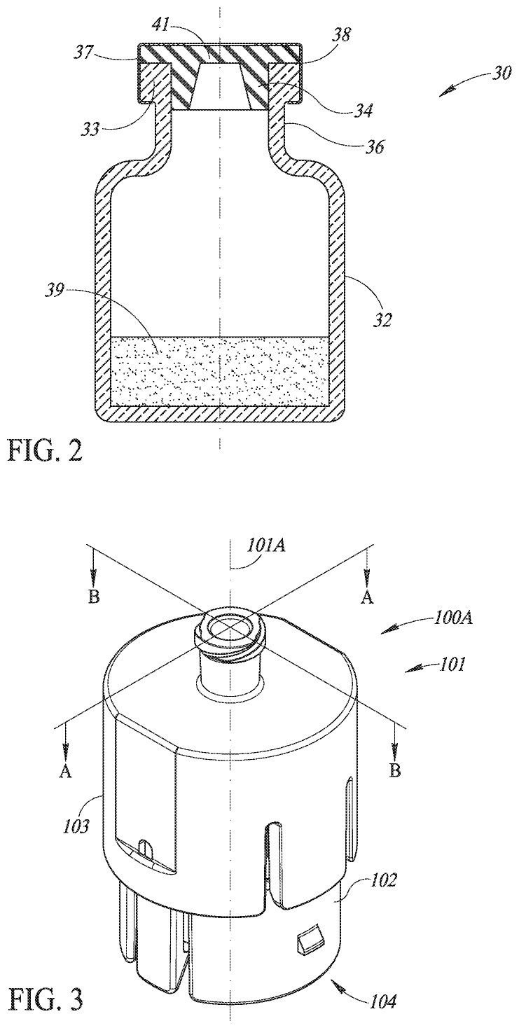

FIG. 1 and FIG. 2 show the injection vial 30 has a longitudinal injection vial centerline 31 and includes a closed end vial tube 32, a tubular vial crown 33 having a crown opening 34 and a vial neck 36 intermediate the vial tube 32 and the vial crown 33. The discrete injection vial 30 includes an injection vial stopper 37 for hermetically sealing the crown opening 34. The vial crown 33 is capped by a band 38. The injection vial 30 contains a medicament 39 in the form of powder, liquid, and the like. The medicament 39 together with the syringe's liquid contents form a liquid drug. The injection vial 30 has an uppermost injection vial surface 41 which is sterilized before accessing the injection vial 30 for forming a liquid drug. The injection vial 30 includes a flip-off tamper evidence cap 42 which is removed immediately before use to expose the uppermost injection vial surface 41. The tamper evidence cap 42 is intended to be single use such that it cannot be replaced after removal.

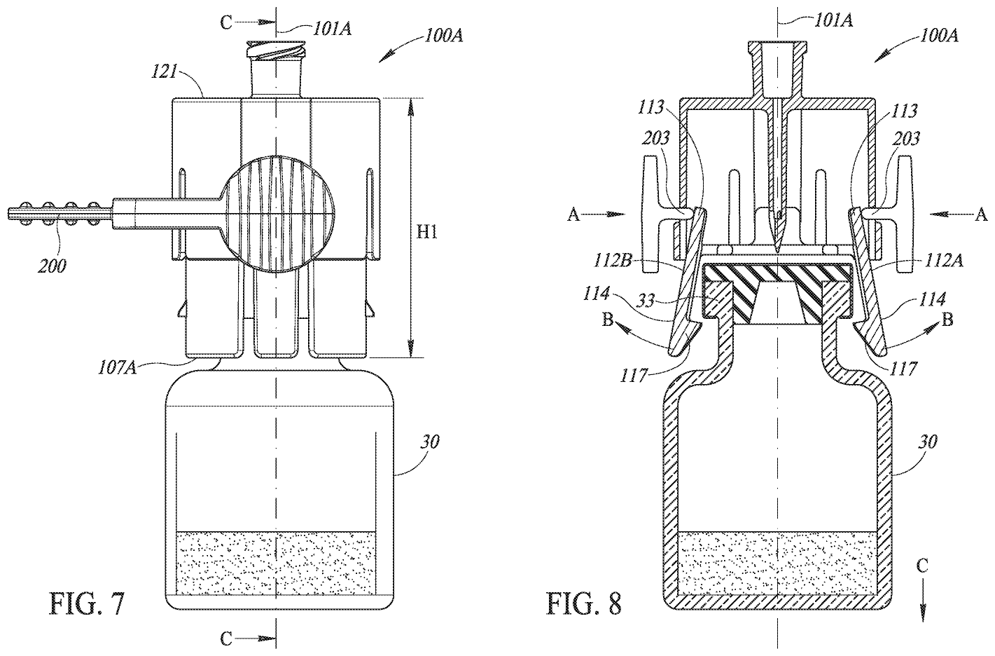

FIG. 1 shows the intact discrete injection vial release tool 200 configured as a pincers-like hand tool including a pincers-like body 201 with an opposite pair of jaws 202 each terminating at an inward directed protrusion 203. The opposite jaws 202 are intended to be manually urged towards one another for applying a pincers-like compression for releasing a non-punctured intact discrete injection vial 30 as described hereinbelow with reference to FIG. 7 and FIG. 8.

FIG. 3 to FIG. 10 show the liquid drug transfer device 100A includes an integral telescopic vial adapter 101 having a longitudinal vial adapter centerline 101A. The integral telescopic vial adapter 101 includes an inner vial adapter body 102, an outer vial adapter body 103 and a clamping arrangement 104 for irreversibly clamping the vial adapter 101 in a compacted state.

The inner vial adapter body 102 has an inverted cup shape with an uppermost transverse annular inner vial adapter body wall 106 and a downward depending vial crown sleeve 107 with a lowermost vial crown sleeve rim 107A. The inner vial adapter body 102 bounds a vial crown cavity 108 for snugly receiving the vial crown 33 therein on telescopically snap fitting the inner vial adapter body 102 thereon. The uppermost transverse annular inner vial adapter body wall 106 has a center uppermost transverse inner vial adapter body wall throughgoing aperture 106A along the longitudinal vial adapter centerline 101A overlying the uppermost injection vial surface 41 on telescopically snap fitting on the discrete injection vial 30.

The vial crown sleeve 107 has a major vial crown sleeve surround 109 with a first adjacent pair of longitudinal slits 111A and a second adjacent pair of longitudinal slits 111B for correspondingly forming a diametric pair of vial crown holding members 112A and 112B. The diametric pair of vial crown holding members 112 are pivotal with respect to the major vial crown sleeve surround 109 such that each vial crown holding member 112 has a proximal vial crown holding member section 113 and a distal vial crown holding member section 114. The uppermost transverse annular inner vial adapter body wall 106 preferably has a diametric pair of throughgoing cutouts 116 inward of the diametric pair of vial crown holding members 112 such that the diametric pair of vial crown holding members 112 pivot on the uppermost transverse annular inner vial adapter body wall 106. The distal vial crown holding member sections 114 each have a radial inward vial crown holding projection 117 toward the lowermost vial crown sleeve rim 107A for snap fitting under the vial crown 33 on telescopically snap fitting the inner vial adapter body 102 on the initially non-punctured intact discrete injection vial 30.

The uppermost transverse annular inner vial adapter body wall 106 includes a diametric pair of upright stops 118A and 118B correspondingly orthogonal to the diametric pair of vial crown holding members 112A and 112B. The vial crown sleeve 107 includes a diametric pair of clamp members 119A and 119B towards the lowermost vial crown sleeve rim 107A and correspondingly orthogonal to the diametric pair of vial crown holding members 112A and 112B. The diametric pair of clamp members 119 constitute a component of the clamping arrangement 104.

The outer vial adapter body 103 has an inverted cup shape with an uppermost transverse outer vial adapter body wall 121 and a downward depending skirt 122. The outer vial adapter body 103 bounds an inner vial adapter body cavity 123 for snugly telescopically receiving the inner vial adapter body 102 therein on compacting the vial adapter 101 from a pre-compacted state to a compacted state. The downward depending skirt 122 has a lowermost skirt rim 122A.

The uppermost transverse outer vial adapter body wall 121 has a downward depending puncturing cannula 124 with a proximal puncturing cannula opening 124A and a distal puncturing cannula tip 124B for puncturing the injection vial stopper 37 for flow communication with the vial tube 32. The uppermost transverse outer vial adapter body wall 121 has an upright liquid transfer port 125 in flow communication with the proximal puncturing cannula opening 124A. The upright liquid transfer port 125 is configured as a female connector for use with the needleless syringe 20. The female connector 125 is preferably configured as a female Luer connector.

The downward depending skirt 122 includes a first adjacent pair of longitudinal slits 126A and a second adjacent pair of longitudinal slits 126B for correspondingly forming a diametric pair of inner vial adapter body holding members 127A and 127B. The diametric pair of inner vial adapter body holding members 127A and 127B correspondingly include internal longitudinal recesses 128A and 128B. The diametric pair of inner vial adapter body holding members 127 with their internal longitudinal recesses 128 constitute a component of the clamping arrangement 104. The diametric pair of internal longitudinal recesses 128A and 128B correspondingly include a diametric pair of lowermost recess rims 129A and 129B. The downward depending skirt 122 includes a diametric pair of throughgoing discrete injection vial release apertures 131A and 131B orthogonal to the diametric pair of inner vial adapter body holding members 127A and 127B.

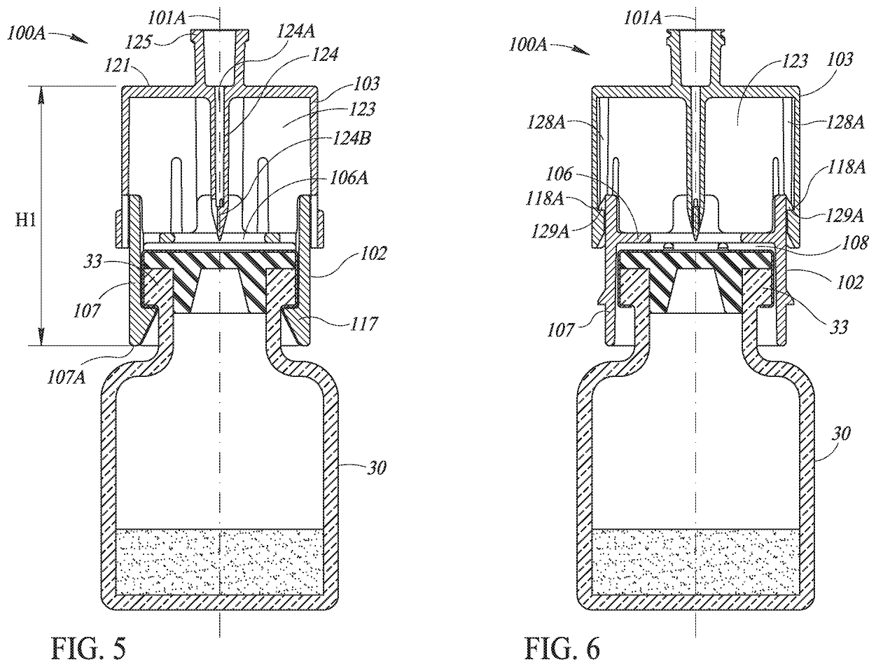

FIG. 5 and FIG. 6 show that in the initial pre-compacted state, the diametric pair of upright stops 118 are disposed at the diametric pair of lowermost recess rims 129 for preventing the inner vial adapter body 102 being inadvertently removed from the outer vial adapter body 103. The distal puncturing cannula tip 124B overlies the non-punctured injection vial stopper 37. The diametric pair of proximal vial crown holding member sections 113 is aligned with the diametric pair of throughgoing discrete injection vial release apertures 131. The vial adapter 101 has a pre-compacted height H1 between the uppermost transverse outer vial adapter body wall 121 and the lowermost downward depending vial crown sleeve rim 107A.

In the event it is decided not to administer the medicament and re-use the non-punctured intact discrete injection vial 30, a healthcare provider takes the following steps as shown in FIG. 7 and FIG. 8: the healthcare provider aligns the pincers-like hand tool 200 with the vial adapter 101 for inserting its opposite pair of inward directed protrusions 203 through the diametric pair of throughgoing discrete injection vial release apertures 131. The healthcare provider applies a pincers-like compression on the diametric pair of proximal vial crown holding member sections 113 for urging them towards the longitudinal vial adapter centerline 101A as denoted by arrows A. The diametric pair of vial crown holding members 112 pivot with respect to the major vial crown sleeve surround 109 thereby distancing the diametric pair of radial inward vial crown holding protrusions 117 away from the longitudinal vial adapter centerline 101A as denoted by arrows B to release the non-punctured intact discrete injection vial 30. The healthcare provider withdraws the non-punctured intact discrete injection vial 30 from the inner vial adapter body 102 as denoted by arrow C.

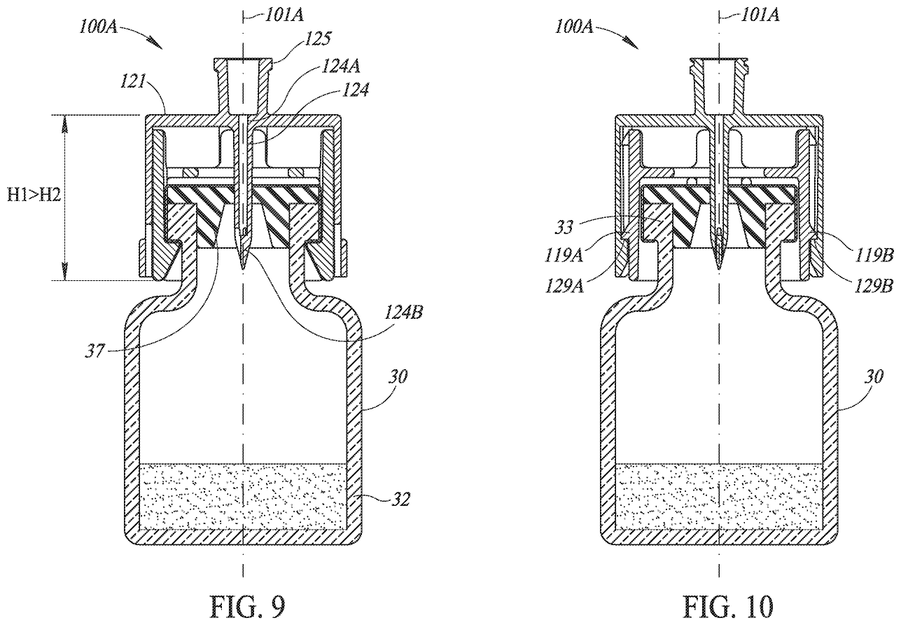

FIG. 9 and FIG. 10 show that in the final compacted state, the diametric pair of clamp members 119 are disposed at the diametric pair of lowermost recess rims 129 for preventing the telescopic vial adapter 101 being reverted to its pre-compacted state. The distal puncturing cannula tip 124B punctures through the injection vial stopper 37 thereby providing flow communication between the upright female Luer connector 125 and the vial tube 32. The diametric pair of proximal vial crown holding member sections 113 are disposed between the uppermost transverse outer vial adapter body wall 121 and the diametric pair of throughgoing discrete injection vial release apertures 131 thereby precluding access thereto for applying the pincers-like compression. The vial adapter 101 has a compacted height H2 equal to the outer vial adapter body 103's height on complete telescopic insertion of the inner vial adapter body 102 therein where H2<H1.

In the final compacted state, the healthcare provider can screw thread the needleless syringe 20 to the female Luer connector 125 for introducing its liquid contents into the discrete injection vial 30 for forming a liquid drug therein. Thereafter, the healthcare provider can aspirate the liquid drug from the discrete injection vial 30 for administration purposes.

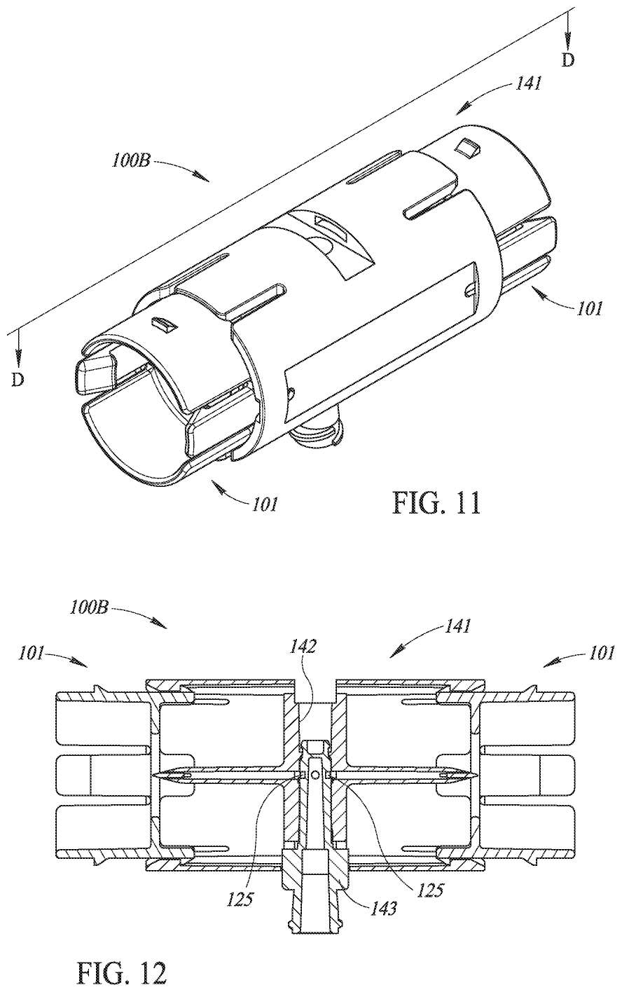

FIG. 11 and FIG. 12 show a liquid drug transfer device 100B similar in construction as commonly owned U.S. Pat. No. 6,379,340 to Zinger et al. hereinafter referred to as the Zinger device. The Zinger device is used with a pair of injection vials and an initially empty needleless syringe. One injection vial includes liquid contents (hereinafter referred to as the liquid vial) and the other injection vial includes a medicament under negative pressure (hereinafter referred to as the drug vial). The Zinger device has a longitudinal housing with a central flow control member port and a lateral pair of vial adapters. The flow control member port includes a flow control member having a syringe port for screw thread attachment of the needleless syringe. The flow control member is rotatable by the syringe port from a first operative position for enabling flow communication between the vial adapters and a second operative position for enabling flow communication between a vial adapter and the syringe port.

The Zinger Instructions For Use (IFU) are follows: the liquid vial is initially inserted in one vial adapter and the drug vial is subsequently inserted in the other vial adapter. The drug vial draws the liquid contents from the liquid vial thereinto to form a liquid drug. The initially empty needleless syringe is connected to the syringe port which is rotated through a quarter turn to enable aspiration of the liquid drug from the drug vial into the needleless syringe. The needleless syringe is detached from the Zinger device for administration of the liquid drug.

The liquid drug transfer device 100B includes an elongated housing 141 having a central flow control member port 142 and a lateral pair of integral telescopic vial adapters 101. The liquid drug transfer device 100B includes a flow control member 143 having a syringe port 144 rotatably mounted in the flow control member port 142. The integral telescopic vial adapters 101 each have a liquid transfer port 125 in flow connection with the central flow control member port 142. The use of the liquid drug transfer device 100B is the same as the Zinger device except that the latter 100B enables preparation of a RTU liquid drug assemblage and release of a non-punctured intact discrete injection vial.

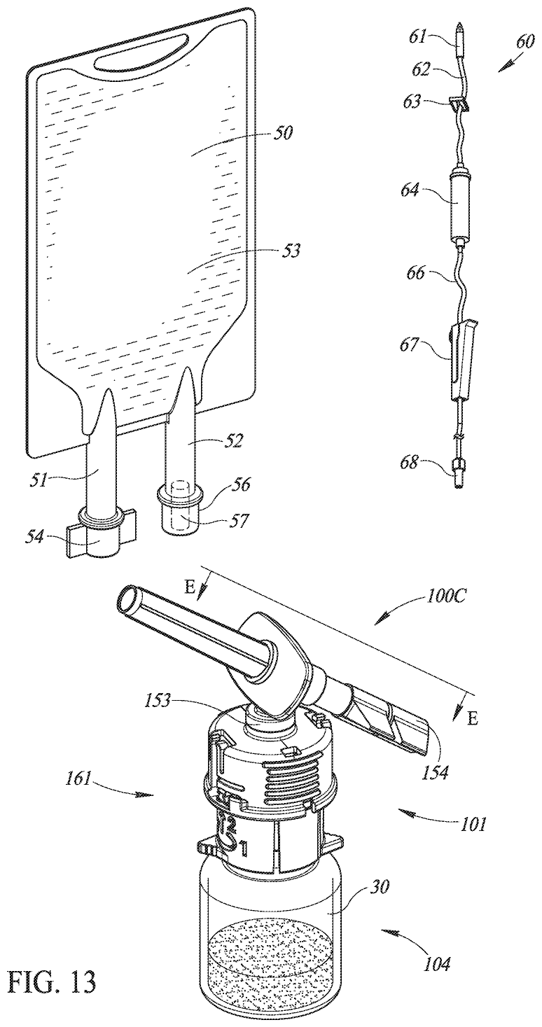

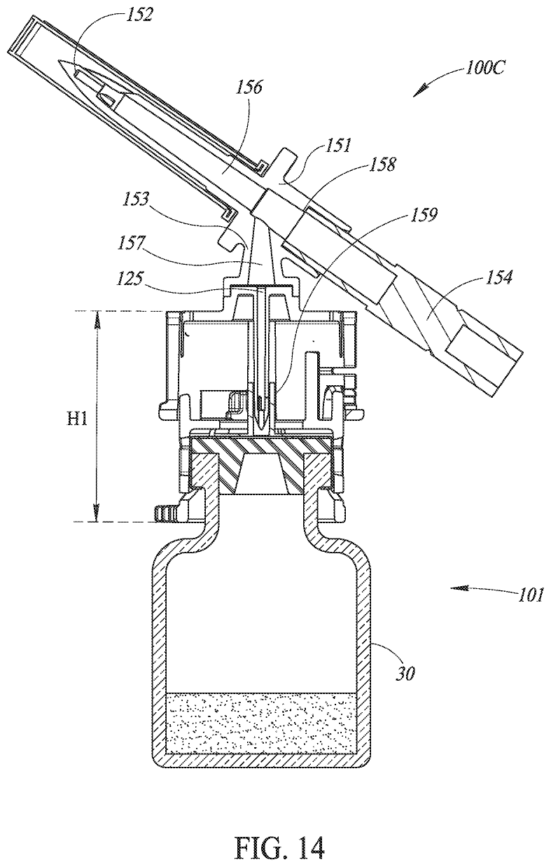

FIG. 13 and FIG. 14 show a liquid drug transfer device 100C for use with an infusion liquid container and an infusion set. The infusion liquid container 50 is constituted by an intravenous (IV) bag having an IV or administration port 51 and an injection port 52 and containing an infusion liquid 53. The IV port 51 is sealed by a twist-off cap 54 for insertion of an IV spike for administration purposes. The injection port 52 terminates in an injection port tip 56 with a seal-sealing plug 57 intended for needle insertion of syringe contents into the IV bag 50. The infusion set 60 includes an IV spike 61 and additionally includes first tubing 62, a clamp 63, a drip chamber 64, second tubing 66, a roller clamp 67, and a male Luer connector 68.

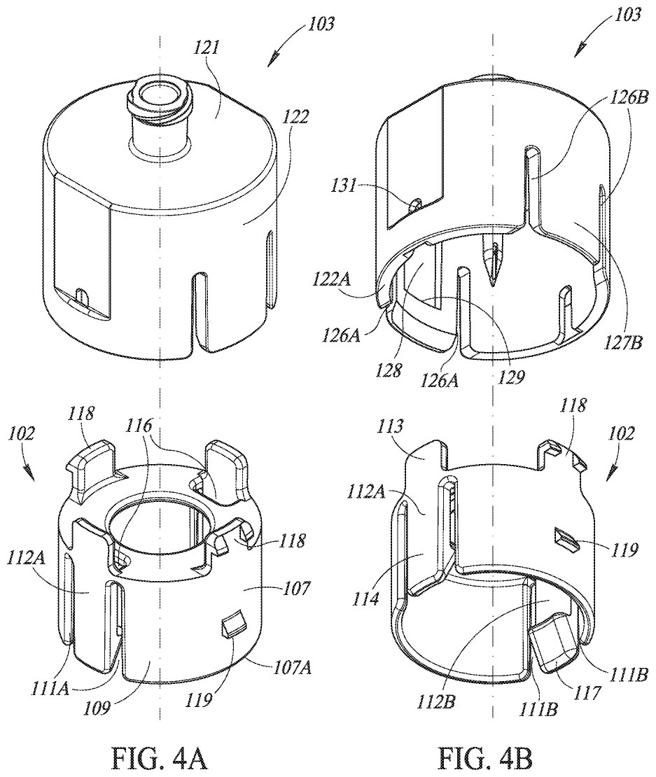

The liquid drug transfer device 100C is similar in construction as the liquid transfer device disclosed in commonly owned US Patent Application Publication No. US 2016/0166824 to Lev et al. FIG. 4 and FIG. 5 hereinafter referred to as the Lev device. The Lev device includes a trifurcated Y-shaped connector body having an IV spike for sealing insertion into the IV port 51, a vial adapter port, and a twist-off substitute IV port. The vial adapter port has an integral vial adapter with a puncturing cannula. The connector body has a lumen terminating at the IV spike, a lumen in flow communication with the puncturing cannula and a lumen terminating at the substitute IV port. The three lumens are in three way direct and continuous fluid connection. The substitute IV port is formed from suitable flexible plastic material, for example, PVC, and the like, for sealing receiving the IV spike 61. The substitute IV port includes a septum intended to be punctured on insertion of the IV spike 61. The substitute IV port includes a proximal section and a distal section. In use, the distal section is twisted and broken off from the proximal section thereby exposing the septum for puncturing by the infusion set's IV spike 61.

The liquid drug transfer device 100C includes a trifurcated Y-shaped connector body 151 having an IV spike 152 for sealing insertion into the IV port 51, a vial adapter port 153, and a twist-off substitute IV port 154. The vial adapter port 153 has an integral telescopic vial adapter 101. The connector body 151 has a lumen 156 terminating at the IV spike 152, a lumen 157 in flow communication with the integral telescopic vial adapter 101 and a lumen 158 terminating at the substitute IV port 154. The three lumens 156, 157 and 158 are in three way direct and continuous fluid connection.

The integral telescopic vial adapter 101 has a liquid transfer port 125 in flow connection with the vial adapter port 153. The integral telescopic vial adapter 101 preferably includes a sealing member 159 mounted on the puncturing cannula 124 for maintaining sterility of the distal puncturing cannula tip 124B and extending the length of time that a RTU liquid drug transfer assemblage can be used. The integral telescopic vial adapter 101 preferably also includes a safety catch mechanism 161 for precluding inadvertent compaction from the pre-compacted state to the compacted state. The safety catch mechanism 161 requires a rotation action for rotating the inner vial adapter body 102 relative to the outer vial adapter body 103 for priming the integral telescopic vial adapter 101 ready for compaction.

The use of the liquid drug transfer device 100C is the same as the Lev device except that the latter 100C enables preparation of a RTU liquid drug assemblage and release of a non-punctured intact discrete injection vial 30.

While particular embodiments of the present invention are illustrated and described, it would be obvious to those skilled in the art that various other changes and modifications can be made without departing from the spirit and scope of the invention.

1. A liquid drug transfer device for use with an initially non-punctured intact discrete injection vial having a closed end vial tube containing a medicament, a tubular vial crown having a crown opening stopped by a non-punctured injection vial stopper, and an uppermost injection vial surface, and an intact discrete injection vial release tool with an opposite pair of inward directed protrusions for applying a pincers-like compression for releasing a non-punctured intact discrete injection vial from the liquid drug transfer device, the liquid drug transfer device comprising:
(a) an integral telescopic vial adapter having a longitudinal vial adapter centerline and including:
i) an inner vial adapter body having an inverted cup shape with an uppermost transverse annular inner vial adapter body wall and a downward depending vial crown sleeve having a lowermost vial crown sleeve rim,
said inner vial adapter body bounding a vial crown cavity for receiving the vial crown on telescopically snap fitting said inner vial adapter body thereon,
said vial crown sleeve having a major vial crown sleeve surround and a diametric pair of vial crown holding members pivotal with respect to said major vial crown sleeve surround such that each said vial crown holding member has a proximal vial crown holding member section and a distal vial crown holding member section,
each said distal vial crown holding member section having a radial inward vial crown holding projection toward said lowermost vial crown sleeve rim for snap fitting under the vial crown on said telescopically snap fitting said inner vial adapter body on the initially non-punctured intact discrete injection vial,
said diametric pair of vial crown holding members being pivotal with respect to said major vial crown sleeve surround such that application of the pincers-like compression on said diametric pair of proximal vial crown holding member sections towards said longitudinal vial adapter centerline distances said diametric pair of radial inward vial crown holding projections from said longitudinal vial adapter centerline, and
ii) an outer vial adapter body having an inverted cup shape with an uppermost transverse outer vial adapter body wall and a downward depending skirt,
said outer vial adapter body bounding an inner vial adapter body cavity for snugly telescopically receiving said inner vial adapter body therein on compacting said integral telescopic vial adapter from an initial pre-compacted state having a pre-compacted height H1 to a final compacted state having a compacted height H2 where H1>H2,
said uppermost transverse outer vial adapter body wall having a downward depending puncturing cannula with a proximal puncturing cannula opening and a distal puncturing cannula tip for puncturing the injection vial stopper for flow communication with the vial tube, and
iii) a clamping arrangement for irreversibly clamping said vial adapter in said final compacted state,
said vial adapter being configured such that in said pre-compacted state, said distal puncturing cannula tip overlies the non-punctured injection vial stopper and said diametric pair of proximal vial crown holding member sections are accessible for said pincers-like compression for releasing the non-punctured intact discrete injection vial from said inner vial adapter body, and in said final compacted state, said distal puncturing cannula tip punctures through said injection vial stopper for flow communication with the vial tube and said downward depending skirt precludes access to said diametric pair of proximal vial crown holding member sections; and
(b) a liquid transfer port in flow communication with said proximal puncturing cannula opening.

2. The device according to claim 1 wherein said downward depending skirt includes a diametric pair of throughgoing discrete injection vial release apertures shaped and dimensioned for providing access to the intact discrete injection vial release tool for applying said pincers-like compression to said diametric pair of proximal vial crown holding member sections in said initial pre-compacted state of said vial adapter.

3. The device according to claim 1 wherein said diametric pair of vial crown holding members pivot on said uppermost transverse annular inner vial adapter body wall on said application of the pincers-like compression.

4. The device according to claim 1 wherein said integral telescopic vial adapter includes a safety catch mechanism requiring a release action for enabling compaction of said integral telescopic vial adapter from said pre-compacted state to said compacted state.

5. The device according to claim 1 configured as a vial adapter and said liquid transfer port is a connector.

6. The device according to claim 1 configured for use with a pair of initially non-punctured intact discrete injection vials and a needleless syringe.

7. The device according to claim 1 configured for use with an infusion liquid container and an infusion set.

8. The intact discrete injection vial release tool with the opposite pair of inward directed protrusions for use with the device according to claim 1 being configured as a pincers-like hand tool having an opposite pair of jaws with the opposite pair of inward directed protrusions.
